(19) United States
(12) Patent Application Publication
(10) Pub. No.: US 2015/0269801 A1
(43) Pub. Date: Sep. 24, 2015

(54) METHOD FOR LINKING A VEHICLE KEY TO A CONTROL UNIT FOR ACCESS AUTHORIZATIONS OF A VEHICLE

(71) Applicant: Vodafone GmbH, Dusseldorf (DE)

(72) Inventor: Robin Friedrich, Haltern am See (DE)

(21) Appl. No.: 14/662,290

(22) Filed: Mar. 19, 2015

(30) Foreign Application Priority Data
Mar. 21, 2014 (DE) 10 2014 103 889.4

(51) Int. Cl. G07C 9/00

(52) U.S. Cl. CPC G07C 9/00857; G07C 9/00007; G07C 9/00309; G07C 2009/00769

(57) ABSTRACT

The invention relates to a method for linking a vehicle key (10) to a control unit (20) for access authorizations of a vehicle (100), comprising the following steps:
selecting a coding (12) of a vehicle key (10) from a vehicle database (210) for a vehicle (100) to be linked,
transmitting the selected coding (12) of the vehicle key (10) to the vehicle (100) to be linked,
storing the transmitted coding (12) in the control unit (20) for access authorizations of the vehicle (100) to be linked as coding (12) of a linked vehicle key (10).

### CROSS REFERENCE TO RELATED APPLICATIONS

This application claims priority of German patent application number 2014 103 889.4 filed Mar. 21, 2014, the entire disclosure of which is incorporated by reference herein.

### FIELD OF THE INVENTION

The present invention relates to a method for linking a vehicle key to a control unit for access authorizations of a vehicle, a corresponding control unit for access authorizations of a vehicle and a computer program product for executing a corresponding method.

### BACKGROUND OF THE INVENTION

It is known that vehicles provide control units for administering and executing an access authorization check for the vehicle. Thus, for example, modern vehicles are fitted with an access authorization system. A corresponding control unit is capable of verifying an enquiry for access authorizations, for example by depressing a button on a vehicle key and opening the vehicle or leaving in locked based on the result of this verification. The same applies to the vehicle authorization, i.e. for starting the engine. In known vehicles, this is ensured by coding a vehicle key to the corresponding vehicle. The corresponding vehicle key is therefore specifically adapted to the respective vehicle by the programming and coding.

In known vehicles, the coding of the vehicle key in a unique manner to the vehicle brings with it considerable disadvantages. On the one hand, the manufacture and in particular the coding of the vehicle key is associated with high complexity and accordingly also high costs. Flexible solutions in which a vehicle key is intended to be used for different vehicles or different vehicle keys for one vehicle accordingly require a high programming expenditure. Another major disadvantage is the situation when losing a vehicle key. Since the coding of the vehicle key in the vehicle key is made to the vehicle, this lost vehicle key must be programmed out again as a result of great effort in the programming in the vehicle. Here also a great loss of time and accordingly high costs are incurred.

### SUMMARY AND ADVANTAGES OF THE INVENTION

It is the object of the present invention to improve the key management of a vehicle in an inexpensive and simple manner and in particular at the same time ensure a reduction in the security risk.

The preceding object is solved by a method having the features of claim 1, a control unit having the features of claim 11 and a computer program product having the features of claim 14. Further features and details of the invention are obtained from the subclaims, the description and the drawings. In this case, features and details which are described in connection with the method according to the invention naturally also apply in connection with the control unit according to the invention and the computer program product according to the invention and in each case, conversely so that reference is always made or can always be made alternately with regard to the disclosure for the individual aspects of the invention.

The method according to the invention is used for linking a vehicle key to a control unit for access authorizations of a vehicle. For this purpose the method according to the invention comprises the following steps:
selecting a coding of a vehicle key from a vehicle database for a vehicle to be linked,
transmitting the selected coding of the vehicle key to the vehicle to be linked,
storing the transmitted coding in the control unit for access authorizations of the vehicle to be linked as coding of a linked vehicle key.

A method according to the invention is based on the core idea that the vehicle key can have a specific coding. Thus, this coding can for example include a code number which is one-to-one and therefore specific for each physically provided vehicle key. At the same time, this coding need not necessarily be identical to an identification number such as can be included as part of the physical key. Accordingly, the vehicle database contains information about all the vehicle keys which can fundamentally be linked to vehicles. This can, for example, be configured to be specific to the manufacturer. Thus, a multiplicity of codings for a corresponding multiplicity of specific vehicle keys can initially be provided in the vehicle data base without any additional information on a correspondingly linked vehicle. Such vehicle keys with the corresponding coding can also be designated as free or empty vehicle keys. As a result of the linking with a vehicle, a corresponding second column in the vehicle database can be described with the linked vehicle. Thus, the correlation via this linking is formed in the vehicle database which for example is located within a network of the vehicle manufacturer or a corresponding fleet management unit. However, the information about the linking between vehicle and vehicle key is not located in the vehicle key itself. The vehicle key itself is accordingly a component which is simple and cheap to manufacture which without its own intelligence only acquires the access functionality through the linking of the vehicle to the coding of the vehicle key and the corresponding storage in the control unit of the vehicle.

The transmission of the selected coding is in this case in particular made by radio or in a wireless manner. It is particularly preferred if the mobile telephone system explained in further detail subsequently is used to provide a corresponding transmission of the selected coding.

The selection of the coding can be made manually, partially automatically or automatically. Thus, for example, a method according to the invention can be started directly upon allocating a physical free or empty vehicle key by selecting the coding corresponding to this empty vehicle key. It is also feasible that the method according to the invention is started by manual input if, for example, a dealer physically hands over a correspondingly empty vehicle key to the user. It is feasible that a vehicle key is sent by post physically to the user of the vehicle and the method according to the invention is only started after the safe receipt of the vehicle key has been acknowledged.

According to the invention, the individual information is separated. The information about the linking between vehicle keys and vehicles is in this case only available outside the vehicle. The information about the possibility of the access authorization is exclusively available in the vehicle during communication between vehicle key and vehicle. The linking can only be set up and also cancelled by the relevant communication between this vehicle-external network and the corresponding vehicle database on the one hand and the corresponding control unit in the vehicle on the other hand. A storage of a transmitted coding can naturally also be understood as an overwriting. Thus, for example, in the case of losing a vehicle key, the old vehicle key and its corresponding coding can so to speak be deleted by overwriting the previously stored vehicle key and the relevant coding with a new transmitted coding. A blocking of the lost vehicle key can thus be carried out cheaply, simply and in particular very rapidly for this case of loss. The replacement can also take place rapidly since, for example, already available physical empty vehicle keys can be issued to the user of the vehicle. Since the release is now again made by selecting from the vehicle database and performing the method according to the invention, not only the deletion of the lost vehicle key but also the replacement by a new linked vehicle key can be accomplished rapidly, simply and particularly inexpensively.

A control unit in the sense of the present invention is in particular a module which is capable of setting up a mobile telephone connection. In particular vehicles nowadays have so-called M2M modules which are equipped with a SIM card for the unique identification of the vehicle in a mobile telephone network. Such a module can, for example, form a control unit according to the invention or be part of such a control unit. Such a control unit can be structure-integrated or as a separate module also have a checking facility, for example, in the form of a checking module to carry out a check of the access authorization, as will be explained in further detail subsequently.

It can be advantageous if, in the method according to the invention, the transmission of the selected coding is made via a mobile telephone network, in particular with encrypted transmission at least for the last section to the vehicle. It is to be understood by this that a mobile telephone network is used as it is for telecommunications services. By providing a control unit with a corresponding mobile telephone module or SIM module, the vehicle can be registered via this control unit in an existing mobile telephone network. Thus, the transmission step of a method according to the invention can be achieved via an existing facility for wireless connection to the vehicle. The part of the transmission which leads through a public last section to the vehicle is preferably made in an encrypted manner. It is also advantageous in a method according to the invention if the control unit is configured to be unidirectional or is configured specifically for the receipt and transmission with a single one or a defined specific number of networks. It should be understood by this that despite the openness of the mobile telephone network, the vehicle and the corresponding control unit can only receive information and therefore codings from a location previously specified for the vehicle, namely a corresponding network. This delinking despite using a public part of the mobile telephone network leads to a further increase in security of a method according to the invention.

It is further advantageous if, in a method according to the invention, the control unit after storing the transmitted coding transmits an acknowledgement about the status and/or the success of the storage to the vehicle database. It is therefore possible that not only the transmission and therefore the attempt at linking the coding of the vehicle key to the vehicle is deposited in the vehicle database but rather as a result of the acknowledgement, also the success of this storage. Thus, for example, via a third column in the vehicle database information can be given that the transmission has actually been successful and a corresponding storage with activated linking in the vehicle is present. Further information such as, for example, the date of the transmission or earlier vehicle linkings can also be stored in additional columns in the vehicle database. This results in a higher information content of the vehicle database. The acknowledgement about the status and about the success of the storage is furthermore an increase in the security for a method according to the invention.

It can also be advantageous if, in the method according to the invention, the control unit for storing the transmitted coding comprises at least one of the following databases:
SIM database of a SIM card of a SIM module of the control unit,
coding data base of a checking module of the control unit.

Accordingly, along with the possibility of a single structure, a control unit can also comprise a combined structure of various modules. The different modules preferably communicate with one another so that when filing the storage of the transmitted coding in the SIM database of a SIM module in the SIM card, a corresponding interrogation can be carried out for the checking step of the control unit. Naturally the information can also be filed in various databases. The storage in the SIM card, in particular in the SIM database of the SIM card leads to a further advantage with regard to security considerations since the encryption there and in particular protection against undesired external access is still further improved.

According to the invention it is advantageous if, in a method according to the invention, the storage of the respective database is accomplished in encrypted form. The encryption is preferably provided inside the control unit so that this encryption can be cancelled exclusively for carrying out the checking of an access authorization of a vehicle key. A subsequent change request within the database is therefore preferably excluded. The storage inside the database can exclusively be changed from outside, in particular by a specifically allocated network as has already been explained. Consequently the information about the access authorization is certainly available within the encrypted database but an undesired and in particular improper change of the stored data in the respective database cannot be carried out, or only with very great effort.

It is furthermore advantageous if, in a method according to the invention, the coding of the vehicle key is designed for a checking of the access authorization of the vehicle key on the basis of a combination of object and solution. As has already been explained in the introduction to this application, the coding of the vehicle key need not necessarily include the identification authorization. In order to obtain an access authorization to the vehicle, for example, a technology can be used in which the control unit sends an object to a vehicle key which sends back the corresponding solution. This has the result that no longer the actual key but rather the result of a key-specific algorithm is transmitted. The radio communication for the access authorization is in this way significantly increased with regard to its security. In order to ensure that this increased security function can be realized by a method according to the invention, the coding of the vehicle key according to the invention already has an appropriate facility for checking for the combination of the object and the solution in a specific manner for the respective vehicle key.

It is a further advantage if, in a method according to the invention with the selected coding, a status of the access authorization of this selected coding is co-transmitted and stored in the control unit of the vehicle. The status of the access authorization allows different stages of the access authorization. This can be of a real physical nature or also of a temporal nature. Thus, for example, a vehicle key can be linked to a vehicle where exclusively a defined time interval is released for the access authorization. Also a vehicle key can be provided with an expiry date so that after expiry of the defined expiry date the linking is again automatically cancelled. Here also a corresponding feedback and relevant storage can naturally always take place in the vehicle database.

In a method according to the preceding paragraph, it can be advantageous if at least one of the following is transmitted and stored as the status of the access authorization:
access to the boot;
access to the interior;
authorization to drive;
speed authorization;
time limit.

The preceding listing is not an exhaustive list. Naturally individual codings and accordingly individual vehicle keys can also have combined access authorizations. Thus, substantially free key management of the respective vehicle key can be selected for different access authorizations. Thus, for example, new drivers can be provided with a maximum speed limit and a correspondingly coded vehicle key. For fleet management or rental car firms a corresponding time limit can be used for the driving authorization and therefore linking for the vehicle key as a reflection of the contractual data in the rental details. A flexible handling of this key management by a method according to the invention significantly reduces the expenditure and in particular the coordination with a number of vehicles in a fleet.

It is a further advantage if, in a method according to the invention, before selecting the coding a linking enquiry is transmitted to the vehicle database. A linking enquiry is therefore the trigger or the starting point from which the method according to the invention starts with regard to the further steps. Thus, for example from a terminal at the vehicle manufacturers when selling the vehicle, a hitherto free vehicle key can be linked to the vehicle by a method according to the invention. Also in the already indicated vehicle management system the corresponding free or empty vehicle key can be linked to a desired vehicle in this way simply, inexpensively and rapidly. In vehicle management systems even all employees can be provided with their own vehicle keys so that exclusively by starting the method according to the invention with the linking enquiry, the corresponding linking and therefore the assignment of a respectively free available vehicle to the respective employee is possible. In order to equip this linking enquiry with the specific coding of the vehicle key, prior to this step information of the empty key can be read in, for example, via an RFID or a barcode or a corresponding readout can be made with NFC or Bluetooth technology.

A method according to the invention can be further developed in that before selecting the coding of a vehicle key, the vehicle key which corresponds to this coding to be selected is physically sent to a user of the vehicle. This is to be understood in particular as dispatch by post. A particularly high security advantage of the method according to the invention can thus be readily identified here. As long as the vehicle key is not yet linked to the vehicle by a method according to the invention, it is so to speak a free or empty vehicle key whose loss on a simple and inexpensive postal dispatch route is not disadvantageous. Only when the vehicle key has physically arrived at the end point of the dispatch route, can the linking be carried out by a method according to the invention, for example, by starting the linking enquiry. This facilitates the distribution of a vehicle key according to the invention and in particular the costs for this effort.

Likewise the subject matter of the present invention is a control unit for access authorizations of a vehicle, comprising a communication interface for receiving a selected and transmitted coding of a vehicle key. Furthermore, a control unit according to the invention comprises a database for storage of the transmitted coding as coding of a linked vehicle key. A control unit according to the invention preferably comprises a processor unit for executing a method according to the invention. Thus a control unit according to the invention brings with it the same advantages as have been explained in detail with reference to a method according to the invention.

A control unit according to the invention can be further developed in that this is configured for a restricted communication link, in particular with at least a single predefined network. Thus, for example, by allocating a particular APN (Access Point Name), the control unit can be focused in a defined manner onto a corresponding communication link to a single one or several specific networks. In particular, this comprises the corresponding network for linking the relevant manufacturer of the vehicle. Thus, even when using a publicly available mobile radio network, a misuse of the linking step in a method according to the invention can be avoided with high security.

A further subject matter of the present invention is a computer program product for execution on a processor unit, in particular on a linking unit according to the invention, and stored on a computer-readable medium, comprising:
computer-readable program means which cause the processor unit to select a coding of a vehicle key from a vehicle database for a vehicle to be linked,
computer-readable program means which cause the processor unit to transmit the selected coding of the vehicle key to the vehicle to be linked,
computer-readable program means which cause the processor unit to store the transmitted coding in the control unit for the access authorization of the vehicle to be linked as coding of a linked vehicle key.

### BRIEF DESCRIPTION OF THE DRAWING VIEWS

Further advantages, features and details of the invention are obtained from the following description in which exemplary embodiments of the invention are described in detail with reference to the drawings. In this case, the features mentioned in the claims and in the description are each essential to the invention individually by themselves or in any combination. In the figures schematically:

FIG. 1 shows a first embodiment of a method according to the invention,

FIG. 2 shows an embodiment of a control unit according to the invention.

### DETAILED DESCRIPTION OF THE INVENTION

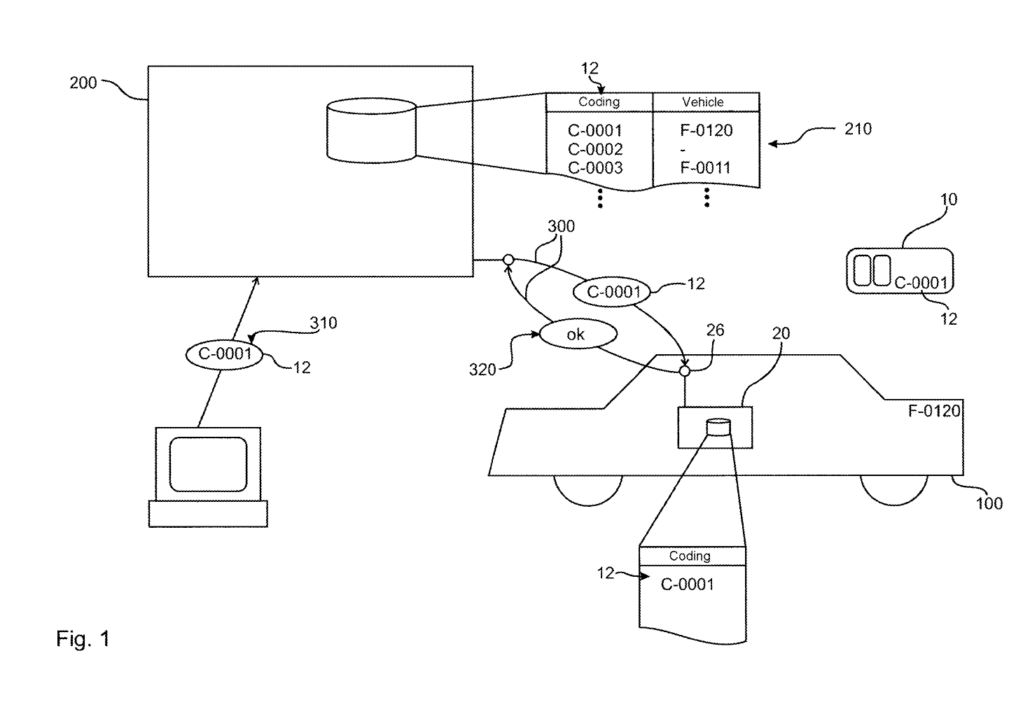

FIG. 1 shows schematically a possible sequence of a method according to the invention. Thus, in physical form a vehicle key 10 is provided which has a specific coding 12, namely here C-0001. This physically present vehicle key 10 can, for example, already be present at a user of a vehicle 100, here having the identification F-0120. In order to now obtain an access authorization with this defined and specific vehicle key 10 to the respective vehicle 100, a method according to the invention is executed. Thus, a linking enquiry 310 can be sent from a terminal which contains the corresponding coding 12, i.e. here C-0001. This can be sent, for example, at the vehicle dealer who has handed over this vehicle key 10 to the user of the vehicle 100 in a physical manner.

The network 200 in particular comprises the manufacturer network of the manufacturer of this vehicle 100. There, a vehicle database 210 is provided with at least two columns. The codings 12 of most diverse free vehicle keys 10 are arranged in the first column. In the second column specifically for the respective coding 10 the individual vehicles 100 are also provided with codings. In this case, the method according to the invention is carried out as follows for the previously empty vehicle key 10 with the coding 12 having the No. C-0001. Starting from the network 200 the coding 12 having the No. C-0001 is transmitted via a mobile telephone network 300 to the control unit 20 of the relevant specific vehicle 100. There likewise in a database the coding 12 with the No. C-0001 is likewise stored. By means of a status acknowledgement 320, the vehicle database 210 is informed of the success of the storage so that now the vehicle coding appertaining to the transmitted and selected coding 12, here F-0120 is now stored in this vehicle database. The method according to the invention is thereby concluded and a linking of the specific vehicle key 10 to the vehicle 100 takes place. Now in a known manner an access authorization with successful checking can take place between the vehicle 100 and this specific vehicle key 10.

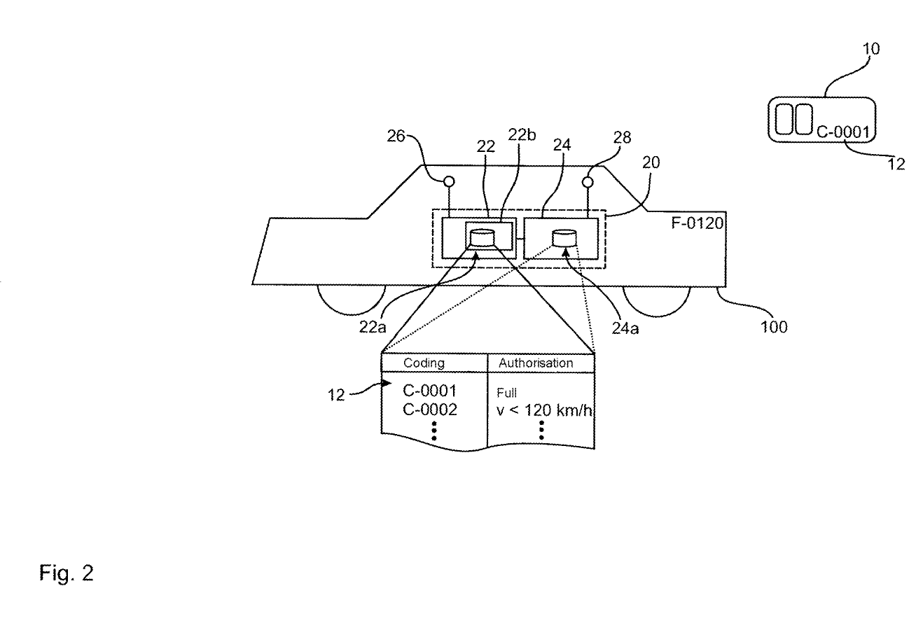

FIG. 2 shows schematically how a control unit 20 according to the invention can be constructed in the vehicle 100. Along with a structural unit, a structural separation into a SIM module 22 and a checking module 24 can be provided here. A SIM card 22b with a corresponding SIM database 22a is disposed in the SIM module 22. Via the communication interface 26, the SIM module 22 makes a communication connection to a mobile telephone network 300 and from there obtains the transmitted coding 12.

A checking module 24 is provided here as another module in which a coding database 24a can alternatively or additionally also be provided. A communication between the two modules 22 and 24 ensures the functionality of the access authorization. By means of a checking interface 28 the access authorization of a corresponding vehicle key 10 can advantageously also be monitored by radio by means of an object and solution communication.

In the embodiment according to FIG. 2, the databases inside the SIM module 22 and/or the checking module 24 are furthermore provided with a second column. Thus, in this example, two vehicle keys 10, namely the codings C-0001 and C-0002 are equipped with an access authorization for the vehicle 100. However, only the first vehicle key 10 with the coding C-0001 has the full access authorization whilst the second vehicle key with the coding C-0002 has a speed restrictions as status of the access authorization.

The preceding explanation of the embodiments describes the present invention exclusively within the framework of examples. Naturally individual features of the embodiments, as long as technically meaningful, can be combined freely with one another without departing from the framework of the present invention.

### REFERENCE LIST

10 Vehicle key
12 Coding
20 Control unit
22 SIM module
22a SIM database
22b SIM card
24 Checking module
24a Coding database
26 Communication interface
28 Checking interface
100 Vehicle
200 Network
210 Vehicle database
300 Mobile telephone network
310 Linking enquiry
320 Status feedback

What is claimed is:

1. A method for linking a vehicle key (10) to a control unit (20) for access authorizations of a vehicle (100), comprising the following steps:
selecting a coding (12) of a vehicle key (10) from a vehicle database (210) for a vehicle (100) to be linked,
transmitting the selected coding (12) of the vehicle key (10) to the vehicle (100) to be linked,
storing the transmitted coding (12) in the control unit (20) for access authorizations of the vehicle (100) to be linked as coding (12) of a linked vehicle key (10).

2. The method according to claim 1, characterized in that the transmission of the selected coding (12) is made via a mobile telephone network (300), in particular with encrypted transmission at least for the last section to the vehicle (100).

3. The method according to claim 1, characterized in that after storing the transmitted coding (12) the control unit (20) transmits an acknowledgement about the status and/or the success of the storage to the vehicle database (210).

4. The method according to claim 1, characterized in that the control unit (20) for storing the transmitted coding (12) uses at least one of the following databases:
SIM database (22a) of a SIM card (22b) of a SIM module (22) of the control unit (20),
coding data base (24a) of a checking module (24) of the control unit (20).

5. The method according to claim 4, characterized in that the storage in the respective database is accomplished in encrypted form.

6. The method according to claim 1, characterized in that the coding (12) of the vehicle key (10) is designed for a checking of the access authorization of the vehicle key (10) based on a combination of problem and solution.

7. The method according to claim 1, characterized in that with the selected coding (12) a status of the access authorization of this selected coding (12) is co-transmitted and stored in the control unit (20) of the vehicle (100).

8. The method according to claim 7, characterized in that at least one of the following is transmitted and stored as the status of the access authorization:
access to the boot;
access to the interior;
authorization to drive;
speed authorization;
time limit.

9. The method according to claim 1, characterized in that before selecting the coding (12) a linking enquiry (310) is transmitted to the vehicle database (210).

10. The method according to claim 1, characterized in that before selecting the coding (12) of a vehicle key (10), the vehicle key (100) which corresponds to this coding (12) to be selected is physically sent to a user of the vehicle (100).

11. Control unit (20) for access authorizations of a vehicle (100) comprising a communication interface (26) for receiving a selected and transmitted coding (12) of a vehicle key (10), further comprising a database for the storage of the transmitted coding (12) as coding (12) of a linked vehicle key (10).

12. The control unit (20) according to claim 11, characterized in that this comprises a processor unit for executing a method having the features of claim 1.

13. The control unit (20) according to claim 11, characterized in that this is configured for a restricted communication connection, in particular to at least one single predefined network (200).

14. A computer program product for execution on a processor unit, in particular on a control unit (20) having the features of claim 11, and stored on a computer-readable medium, comprising:
non transitory computer readable program means which cause the processor unit to select a coding (12) of a vehicle key (10) from a vehicle database (210) for a vehicle (100) to be linked,
non transitory computer readable program means which cause the processor unit to transmit the selected coding (12) of the vehicle key (10) to the vehicle (100) to be linked,
non transitory computer readable program means which cause the processor unit to store the transmitted coding (12) in the control unit (20) for the access authorizations of the vehicle (100) to be linked as coding (12) of a linked vehicle key (10).
